(19) United States
(12) Patent Application Publication
(10) Pub. No.: US 2016/0283516 A1
(43) Pub. Date: Sep. 29, 2016

(54) METHOD AND APPARATUS FOR PROVIDING MAP SELECTION AND FILTERING USING A DRAWING INPUT

(71) Applicant: HERE Global B.V., Veldhoven (NL)

(72) Inventors: Craig BARNES, Forest Park, IL (US); Aaron RINCOVER, Munich (DE); Arnaud DE VALLOIS, Chicago, IL (US); Marco KRAUS, Chicago, IL (US)

(21) Appl. No.: 14/669,827

(22) Filed: Mar. 26, 2015

(51) Int. Cl. G06F 17/30; G06F 3/0488; G06F 3/0484

(52) U.S. Cl. CPC G06F 17/30241; G06F 3/04842; G06F 3/04883

(57) ABSTRACT

An approach is provided for processing drawing inputs on a mapping user interface to select one or more map elements. An interaction platform receives a drawing input via the mapping user interface. Next, the interaction platform processes the drawing input to determine one or more selection parameters of at least one spatial query. Thereafter, the interaction platform queries at least one spatial index based, at least in part, on the one or more selection parameters, the at least one spatial query, or a combination thereof to determine one or more map elements. Subsequently, the interaction platform causes, at least in part, a selection of the one or more map elements based, at least in part, on the drawing input.

### BACKGROUND

Service providers and device manufacturers (e.g., wireless, cellular, etc.) are continually challenged to deliver value and convenience to consumers by, for example, providing compelling network services. One area of interest is providing device users with selection of map elements such as buildings, point of interest (POI) etc., along a street or a route. Generally, the interaction with a digital map is limited to searching and selecting a route displayed between a point of origin and a destination. Unfortunately, there is currently no convenient means for enabling users to interact with the maps by sketching or drawing on the map. In addition, the interaction for users is limited to placing markers or drawing preset shapes such as polygons and rectangles on the map and do not enable selection of map elements.

### SOME EXAMPLE EMBODIMENTS

Therefore, there is a need for an approach for processing one or more user interactions and/or drawing inputs on mapping user interface to a cause a selection of one or more map elements based, at least in part, on the drawing inputs.

According to one embodiment, a method comprises receiving a drawing input via a mapping user interface. The method also comprises processing and/or facilitating a processing of the drawing input to determine one or more selection parameters of at least one spatial query. The method further comprises causing, at least in part, a querying of at least one spatial index based, at least in part, on the one or more selection parameters, the at least one spatial query, or a combination thereof to determine one or more map elements, wherein the at least one spatial index indexes one or more footprints of one or more geographic features. The method also comprises causing, at least in part, a selection of the one or more map elements based, at least in part, on the drawing input.

According to another embodiment, an apparatus comprises at least one processor, and at least one memory including computer program code for one or more computer programs, the at least one memory and the computer program code configured to, with the at least one processor, cause, at least in part, the apparatus to receive a drawing input via a mapping user interface. The apparatus is also caused to process and/or facilitate a processing of the drawing input to determine one or more selection parameters of at least one spatial query. The apparatus is further caused to query at least one spatial index based, at least in part, on the one or more selection parameters, the at least one spatial query, or a combination thereof to determine one or more map elements, wherein the at least one spatial index indexes one or more footprints of one or more geographic features. The apparatus is also caused to select the one or more map elements based, at least in part, on the drawing input.

According to another embodiment, a computer-readable storage medium carries one or more sequences of one or more instructions which, when executed by one or more processors, cause, at least in part, an apparatus to receive a drawing input via a mapping user interface. The apparatus is also caused to process and/or facilitate a processing of the drawing input to determine one or more selection parameters of at least one spatial query. The apparatus is further caused to query at least one spatial index based, at least in part, on the one or more selection parameters, the at least one spatial query, or a combination thereof to determine one or more map elements, wherein the at least one spatial index indexes one or more footprints of one or more geographic features. The apparatus is also caused to select the one or more map elements based, at least in part, on the drawing input.

According to another embodiment, an apparatus comprises means for receiving a drawing input via a mapping user interface. The apparatus also comprises means for processing and/or facilitating a processing of the drawing input to determine one or more selection parameters of at least one spatial query determining one or more map features rendered in the mapping user interface. The apparatus further comprises means for causing, at least in part, a querying of at least one spatial index based, at least in part, on the one or more selection parameters, the at least one spatial query, or a combination thereof to determine one or more map elements, wherein the at least one spatial index indexes one or more footprints of one or more geographic features. The apparatus also comprises means for causing, at least in part, a selection of the one or more map elements based, at least in part, on the drawing input.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling a user to select one or more map elements, according to one embodiment;

FIG. 2 is a diagram of the components of the interaction platform 109, according to one embodiment;

FIG. 3 is a diagram of the components of the element selection module 201, according to one embodiment;

FIG. 4 is a diagram of geographic database 111 of system 100, according to exemplary embodiments;

FIG. 5 is a flowchart of a process for selecting map elements for receiving drawing inputs on a mapping user interface, according to one embodiment;

FIG. 6 is a flowchart of a process for determining one or more map elements from one or more input geographic coordinates of one or more footprints, according to one embodiment;

FIG. 7 is a flowchart of a process for causing association of one more points of interests with one more footprints, according to one embodiment;

FIG. 8 is a flowchart of a process for generating annotations of the map elements, according to one embodiment;

FIG. 9 is an exemplary portion of a map illustrating additional points in polygons, according to one embodiment;

FIG. 10 is a diagram of user interface utilized in the processes of FIGS. 5-8, according to one embodiment;

FIGS. 11A-11D are diagrams of user interface utilized in the processes of FIGS. 5-8, according to one embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for allowing the users of a mobile communication device to enabling a user to select one or more map elements from a mapping user interface. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

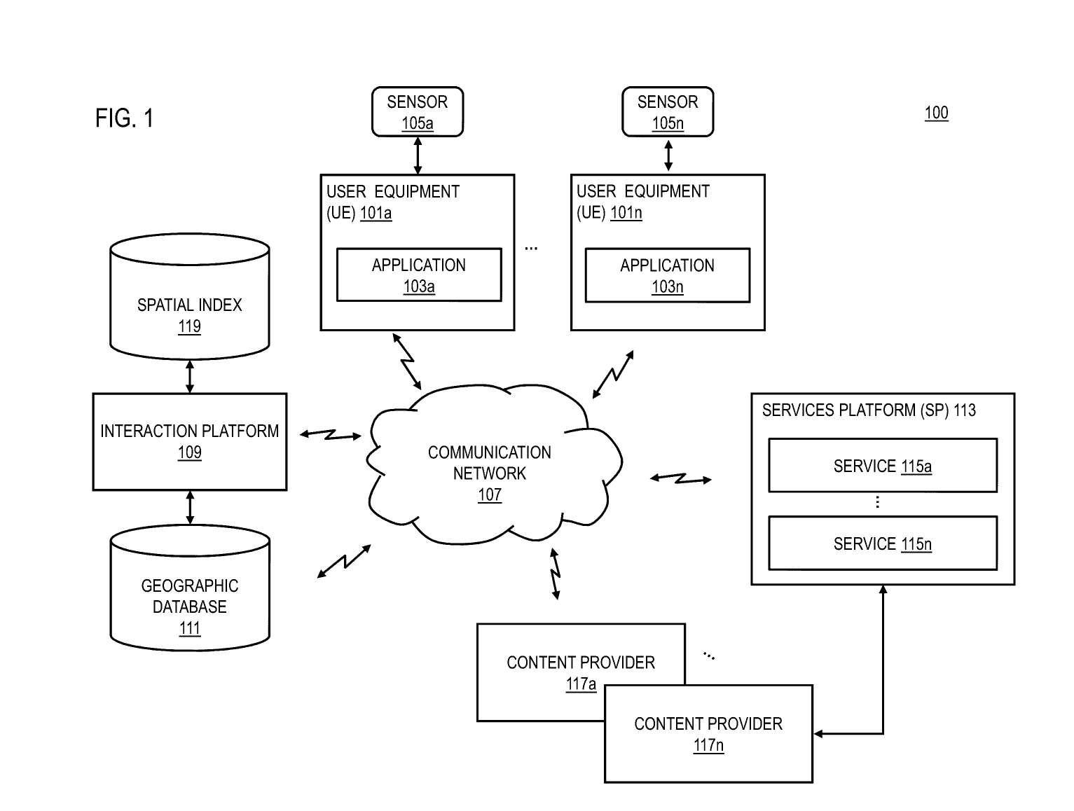

FIG. 1 is a diagram of a system capable of enabling a user to select one or more map elements from a mapping user interface, according to one embodiment. By way of example, a map element may pertain to a building, a park, a waterway, a point of interest (POI), landmarks etc. Typically, the device users can interact with a map to search and select routes displayed between a point of origin and a destination. However, the service providers and device manufacturers (e.g., wireless, cellular, etc.) are continually challenged to provide compelling network services, that may include, map element selection service that enables the users of UE 101 to select map elements by providing drawing inputs. As noted previously, the interaction for the users is limited to placing markers or drawing preset shapes such as polygons and rectangles on the map. These shapes are typically just drawn as a layer that is rendered on user interface of map. However, there is no correlation between the shapes drawn and the map elements or real life counterparts covered by those shapes. For example, a rectangle drawn over a building on the map cannot be used to select, search, or display information about that building. In addition, the users are not able to use arbitrary shapes, write annotations, collaborate or share the map.

To address these issues, a system 100 of FIG. 1 introduces the capability to provide the users with the ability to interact with maps, wherein the interaction platform 109 processes and determines the user drawing inputs with UE 101 to select one or more map elements. In one embodiment, the system 100 makes selection of map elements easier by enabling the users to draw on the mapping user interface. For example, the user can draw arbitrary shapes (e.g., lines, polygons, etc.). As the touch interfaces become more ubiquitous such interaction will become more important and easier to implement. Further, the system 100 determines the map elements selected based on the shapes drawn on the map, to search and provide information about the map elements, enable annotation and/or collaboration of the selection. In one embodiment, the elements selected can optionally be pre-filtered or post-filtered so that only elements of a particular type are selected. In this way, the system 100 can enable a real life or natural way of interaction with user interface of maps.

As shown in FIG. 1, the system 100 comprises user equipment (UEs) 101a-101n (collectively referred to as UE 101) that may include or be associated with applications 103a-103n (collectively referred to as applications 103) and sensors 105a-105n (collectively referred to as sensors 105). In one embodiment, the UEs 101 have connectivity to an interaction platform 109 via the communication network 107. In one embodiment, the interaction platform 109 performs one or more functions associated with receiving drawings inputs provided by the user of UE 101, and causing a selection of map elements, for instance, in conjunction with the applications 103 and/or related services 115a-115n of the services platform 113. By way of example, the applications 103 may be any type of application that is executable at the UE 101, such as mapping applications, navigation applications, and/or any other applications that may use POI information including general applications such as media player applications, social networking applications, content provisioning services, and the like. In one embodiment, one of the applications 103 at the UE 101 may act as a client for interaction platform 109 and perform one or more functions associated with the functions of the interaction platform 109. In addition, the sensors 105 may be any type of sensor. In one embodiment, the sensors 105 may include one or more sensors that may assist the interaction platform 109 to determine POI information to be used with streets associated with UE 101. In one scenario, the sensors 105 may include location sensors (e.g., GPS), light sensors, oriental sensors augmented with height sensor and acceleration sensor, tilt sensors, moisture sensors, pressure sensors, touch sensors, audio sensors (e.g., microphone), or receivers for different short-range communications (e.g., Bluetooth, WiFi, etc.).

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the interaction platform 109 may include or have access to a geographic database 111 to access or store any kind of data associated with POI, such as historical user information, location proximity information, temporal proximity information, contextual proximity information, etc. Data stored in the geographic database 111 may, for instance, be provided by the UEs 101, a service platform 113, one or more services 115a-115n (or services 115), or one or more content providers 117a-117n (or content providers 117). In one embodiment, the interaction platform 109 may include or have access to a spatial index 119 indexes one or more footprints of one or more geographic features. In one embodiment, footprint may include geometry of the one or more geographic features such as one or more buildings, one or more map geographic areas, one or more streets, one or more waterways, one or more paths, or a combination thereof. Further, spatial index 119 may include a unique identifier for each of the one or more geographic features. In one embodiment, the unique identifier may be correlated with the footprints and indexed in the spatial index 119. For example, the unique identifier may be a Building Identifier (BID) that can be used to index and retrieve information about a building from the spatial index 119. In addition, the spatial index 119 may include at least one geographic coordinate (e.g., latitude and longitude) of the one or more geographic features. In one embodiment, the spatial index 119 is based, at least in part, one or more tree data structures, and wherein the one or more tree data structures include, at least in part, a k-dimensional tree data structure, a quadtree data structure, an R*-tree data structure, a R-tree data structure, or a combination thereof. For example, the tree data structure may be a 2D (two dimensional) tree.

In one embodiment, the information in the spatial index 119 is generated, modified, and/or updated by the interaction platform 109. As noted previously, the tree data structure of the spatial index 119 is generated from the footprints of the geographic features on the map. In an exemplary scenario, the footprints of the geographic features on a map are associated with a unique Building Identifier (BID). As noted previously, BID is unique for every geographic feature such as a building, park, etc. The footprints are then extracted to one or more geospatial vector data files containing polygons defining the geometry of the geographic feature. Further, the BID is associated with each polygon. For example, the geospatial vector data files may be an Environmental Systems Research Institute (ESRI) shapefile compatible with Geographic Information System (GIS) software. Each edge of every polygon may be processed and every point on each edge is associated with the BID. In one embodiment, each point on the polygon may be mapped to its corresponding coordinate point (e.g., a local East, North, Up (ENU) tangent plane position). In one embodiment, the distance between the points on the edge may be predefined. By way of example, the predefined distance may be 0.5 meters between two points on the edge. Further, geographical coordinates (i.e., latitude and longitude) of each polygon or the center of shape file may be determined. In one embodiment, the interaction platform 109 determines at least one geographic coordinate of the one or more geographic features based, at least in part, on at least one center point of the one or more polygons. The information related to each point and BID may be inserted in the tree data structure of the spatial index 119. Consequently, the information from spatial index 119 can be queried based on various parameters such as geographical coordinates, distance range or radius from a point, etc.

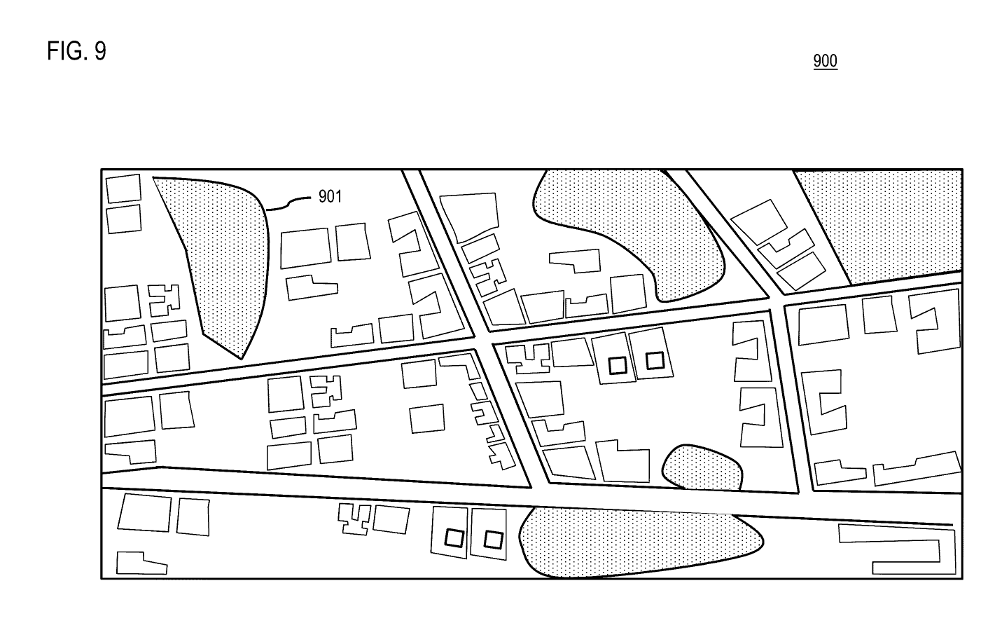

In one embodiment, the interaction platform 109 may a subdivide the one or more polygons, the one or more geographic features, or a combination thereof based, at least in part, on at least one threshold size value. For example, the threshold size value may be a length of an edge or an area of a polygon. By way of example, a geographic feature such a street may be broken down into street map element by intersection points. Therefore, every street spans to only two intersections. Each street map element may then be assigned a new unique identifier or a Feature Identifier (FID). Further, the FID may be correlated with the BID in the spatial index 119. By way of another example, large open areas such as parks may contain no geographical features. In one embodiment, additional points may be added in such large areas so as to permit selection in their interior portions. To achieve this, all the polygons comprising a large open area (e.g., a park) may be merged into one single polygon, and a bounding box (Bp) for this single polygon may be selected. Thereafter, each X and Y coordinates of the bounding box may be iterated to construct a box Bx having X, Y as coordinates of a corner, X+delta as width, and Y+delta as height. In one embodiment, the value of delta may be predefined. For example, the predefined value may be constant arc second value. Each Bx may then be intersected with the single polygon, and if Bx is inside this single polygon then its center is appended to the shape file and/or the spatial index 119. In another embodiment, the value of delta may be modified based on desired density of points on the polygon. An exemplary map portion with subdivided polygons is illustrated in FIG. 9.

In one embodiment, the interaction platform 109 associates one or more Points of Interest (POI) with the one or more footprints, the one or more geographic features, or a combination thereof. For example, the interaction platform 109 may associate POIs with BIDs. Consequently, the one or more geographic features or map elements may be searched, selected, and/or filtered for POIs based on the BIDs. In one embodiment, the information related to the POIs and the BID is indexed in the spatial index 119.

In one embodiment, the interaction platform 109 enables selection of the map elements based on one or more drawing inputs. The interaction platform 109 may receive a drawing input via a mapping user interface. By way of example, the drawing input may be a line, a polygon, a polyline, or any other arbitrary shape drawn by the user on the mapping user interface of UE 101. The drawing input may be processed to determine one or more selection parameters of at least one spatial query. In one embodiment, the selection parameters include, at least in part, one or more input geographic coordinates. For example, the input geographic coordinate may relate to the geographic coordinate of one or more points covered or selected by the drawing input such as a line. In one embodiment, the selection parameters may include one or more type parameters. By way of example, the type parameter may relate to a type of POI such as, a coffee shop, a restaurant, a diner, etc. Further, the spatial query may be a query directed to the spatial index 119 based on the selection parameters. In one embodiment, the interaction platform 109 queries the spatial index 119 based, at least in part, on the one or more selection parameters, the at least one spatial query, or a combination thereof, to determine the one or more map elements. By way of example, a spatial query such as “queryPoint(latitude X, longitude Y, radius R)” directed to the spatial index 119 may provide a list of all BIDs associated with geographic coordinates ‘X’ and ‘Y’, and within a radius ‘R’ of the point on the drawing input. Consequently, the interaction platform 109 causes, at least in part, the selection of the one or more map elements based on the drawing input. In one embodiment, the selected map elements may be presented with a predefined color, a pattern, opacity, stroke width, etc. For example, selected buildings may be highlighted in blue color, while POIs may be highlights in red.

In one embodiment, the interaction platform 109 causes, at least in part, a filtering of the one or more map elements, the one or more POIs, the one or more geographic features, or a combination thereof based, at least in part, on the one or more type parameters. By way of example, the interaction platform 109 may enable the user of UE 101 to select or input a type parameter, so that query results for BIDs may be filtered based on the type parameters. For instance, only restaurants (e.g., type parameter selected by the user) along a line drawn on the mapping user interface may be displayed and selected. Further, in one embodiment, the interaction platform 109 causes generation of annotations of the selected map elements. The annotations may be persistent, collaborative, or a combination thereof. For example, the restaurants selected may be annotated by the user for collaboration or sharing with other users, or persistently stored for a later reference.

In one embodiment, the interaction platform 109 may be a platform with multiple interconnected components. The interaction platform 109 may include multiple servers, intelligent networking devices, computing devices, components and corresponding software for performing the function of enabling the user of UE 101 to select the map elements based on drawing inputs. Further, the interaction platform 109 may assist the user in navigating the UE 101 towards POI that is determined upon the processing of the received user interaction with the UE 101 coupled with the content information of UE 101, for instance, by providing a visual representation of a route for the determined street in a mapping device as visual guidance information to the users. In one embodiment, the user may provide inputs via one or more touch screen inputs or other input means, including drawing inputs, controlling a degree of rotation (e.g., panning) of the route or enabling an expanding of the route for the street. Of note, the interaction platform 109 is configured to process various inputs for facilitating control of the user interface element via operation of the applications 103, geographic database 111 and/or services 115. In another embodiment, the interaction platform 109 enables the user to pan the map at any degree of rotation. As such, the user is able to view a map of the location from any perspective. Moreover, when the user manipulates the user interface element to permit a greater amount of map image to be viewed (e.g., enhanced width) the texts and location anchors may also be expanded to represent an increased view sector. In one embodiment, the interaction platform 109 may cause retrieval of the map images in connection with the service 115, which may further execute the query based on data collected by the sensors 105 of the UE 101.

The services platform 113 may include any type of service. By way of example, the services platform 113 may include mapping services, navigation services, travel planning services, social networking services, content (e.g., audio, video, images, etc.) provisioning services, application services, storage services, contextual information determination services, location based services, information (e.g., weather, news, etc.) based services, etc. In one embodiment, the services platform 113 may interact with the UE 101, the interaction platform 109 and the content providers 117 to supplement or aid in the processing of the content information. In other embodiments, the services platform 113, the services 115, the applications 103, etc. may be used to allow the users of UE 101 to select the map elements.

By way of example, services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability. The services 115 may additionally assist in providing the interaction platform 109 with travel information of the one or more geo-routes and/or location anchors, etc.

The content providers 117 may provide content to the UE 101, the interaction platform 109, and the services 115 of the services platform 113. The content provided may be any type of content, such as textual content, audio content, video content, image content, etc. In one embodiment, the content providers 117 may provide content that may supplement content of the applications 103, the sensors 105, or a combination thereof. By way of example, the content providers 117 may provide content that may aid in the processing of the content information associated with POI. In one embodiment, the content providers 117 may also store content associated with the UE 101, the interaction platform 109, and the services 115 of the services platform 113. In another embodiment, the content providers 117 may manage access to a central repository of data, and offer a consistent, standard interface to data, such as a repository of users' navigational data content.

By way of example, the UE 101, the interaction platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

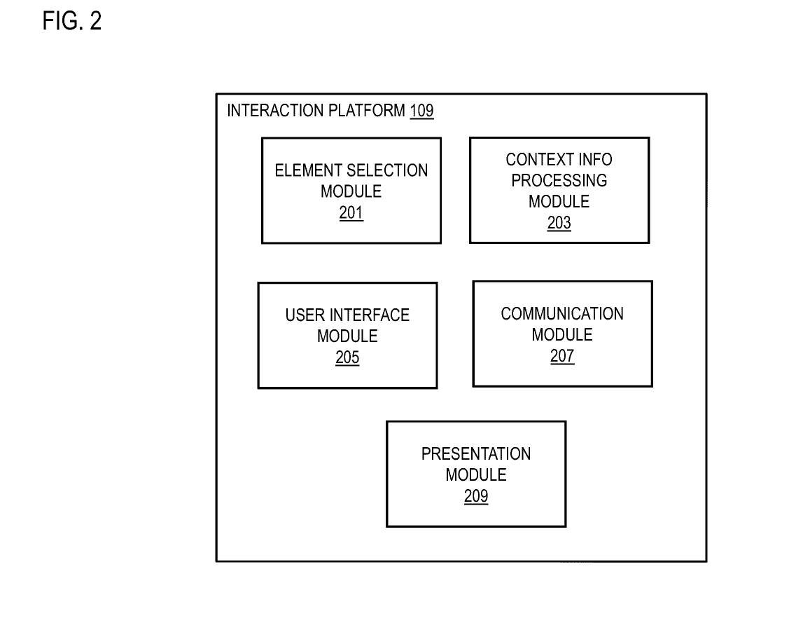

FIG. 2 is a diagram of the components of the interaction platform 109, according to one embodiment. By way of example, the interaction platform 109 includes one or more components for selecting the one or more map elements, according to one embodiment. It is contemplated that the functions of these components may be combined in one or more components or performed by other components of equivalent functionality. In this embodiment, the interaction platform 109 includes an element selection module 201, a context information processing module 203, a user interface module 205, a communication module 207 and a presentation module 209.

In one embodiment, the context information processing module 203 receives context information as gathered by the sensors 105 of respective UE 101 and/or geographic database 111 and/or services 115. Once received, the context information processing module 203 analyzes the context information to determine the relative location, time, position and other information useful for generating a map in association with a specified location. Based on this determination, the context information processing module 203 triggers execution of the element selection module 201, which facilitates the querying/retrieval of associated map image data from geographic database 111 and/or spatial index 119 corresponding to the location.

In one embodiment, the element selection module 201 facilitates gathering of the various map images corresponding to a location selected via a mapping application or service. In addition, the element selection module 201 determines and/or retrieves the various map images corresponding to a specified street. Further, the element selection module 201 facilitates selection of one or more map elements based on drawing inputs from a user. It is noted, in certain embodiments, that the element selection module 201 may facilitate various image rendering, blending, merging and other compilation techniques for producing a user friendly map image.

In one embodiment the user interface module 205 enables presentment of a graphical user interface for presenting map images in connection with a selected geographic feature. By way of example, the user interface module 205 generates the user interface element in response to detection of an input, such as a drawing input for selection of map elements. In addition, the user interface module 205 triggers execution of the various other modules, including the element selection module 201 in response to user input.

The user interface module 205 employs various application programming interfaces (APIs) or other function calls corresponding to the applications 103 of UE 101; thus enabling the display of graphics primitives such as menus, buttons, data entry fields, etc., for generating the user interface elements. Still further, the user interface module 205 may be configured to operate in connection with augmented reality (AR) processing techniques, wherein various different applications, graphic elements and features may interact. For example, the user interface module 205 may coordinate the presentment of augmented reality map images in conjunction with various images for a given location or in response to a selected map element.

In one embodiment, the communication module 207 enables formation of a session over a communication network 107 between the interaction platform 109 and the services 115. By way of example, the communication module 207 executes various protocols and data sharing techniques for enabling collaborative execution between a subscriber's UE 101 and the interaction platform 109 over the communication network 107. Further, communication module 207 enables users of UE 101 to collaborate with one other on the map.

In one embodiment, the presentation module 209 displays the selected map elements, POIs, or other geographic features on the map. The presentation module 209 may utilize the geographic database 111 and/or services 115 to determine whether the information for geographic features is up to date. Further, the presentation module 209 may facilitate presentation of annotations on the map elements. In another embodiment, the presentation module 209 may cause a presentation of map information in the most suitable manner for consistent user experience.

The above presented modules and components of the interaction platform 109 can be implemented in hardware, firmware, software, or a combination thereof. Though depicted as a separate entity in FIG. 1, it is contemplated that the interaction platform 109 may be implemented for direct operation by respective UE 101. As such, the interaction platform 109 may generate direct signal inputs by way of the operating system of the UE 101 for interacting with the applications 103. In another embodiment, one or more of the modules 201-209 may be implemented for operation by respective UEs, as an interaction platform 109, or combination thereof. Still further, the interaction platform 109 may be integrated for direct operation with services 115, such as in the form of a widget or applet, in accordance with an information and/or subscriber sharing arrangement. The various executions presented herein contemplate any and all arrangements and models.

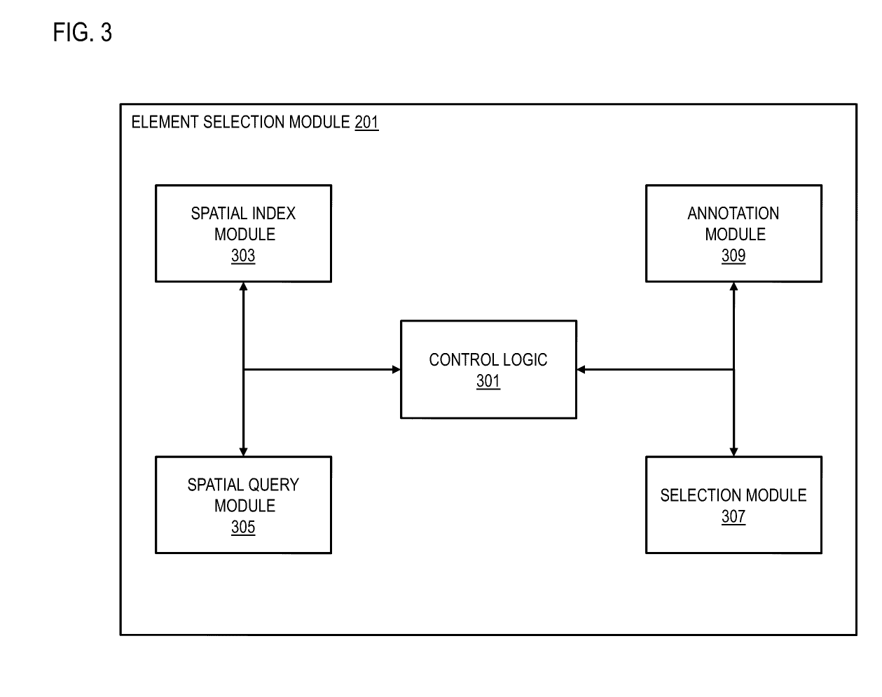

FIG. 3 is a diagram of the components of the element selection module 201, according to one embodiment. By way of example, the element selection module 201 includes one or more components for facilitating selection of one or more map elements. It is contemplated that the functions of these components may be combined in one or more components or performed by other components of equivalent functionality. In this embodiment, the element selection module 201 includes a control logic 301, a spatial index module 303, a spatial query module 305, a selection module 307, and an annotation module 309.

In one embodiment, the control logic 301 may interact with the spatial index module 303 to generate, update, and/or modify the spatial index 119. As noted previously, the spatial index 119 may include information related to the one or more map elements or geographic features. In one embodiment, the spatial index module 303 causes a specification of the one or more footprints using the one or more polygons. Further, the spatial index module 303 causes a subdivision of the one or more polygons, the one or more geographic features, or a combination thereof based. In addition, the spatial index module 303 determines the geographic coordinates of the one or more geographic features based on at least one center point of the one or more polygons. The spatial index module 303 further associates the one or more points of interest with the one or more footprints, the one or more geographic features, or a combination thereof. By way of example, the spatial index module 303 inserts the information such as POI, BID, and/or FID related to the map elements of geographic features in the tree data structure of the spatial index 119.

The control logic 301 triggers the spatial query module 305 based on user interaction received on the user interface module 205. By way of example, the spatial query module 305 is initiated based on a drawing input received from a user on a mapping user interface associated with the UE 101. In one embodiment, the spatial query module 305 processes the drawing input to determine one or more selection parameters of at least one spatial query. As noted previously, the selection parameters include one or more input geographic coordinates. Further, the spatial query module 305 determines the map elements by querying the spatial index 119 based on the selection parameters, the spatial query, or a combination thereof. In one embodiment, the spatial index module 305 determines the map elements based on a comparison of one or more input geographic coordinates against the at least one geographic coordinate of the one or more geographic features. As noted previously, the selection parameters include the input geographic coordinates that may relate to one or more features or points selected by the user.

In one embodiment, the control logic 301 and the spatial query module 305 triggers the selection module 307 to select the one or more map elements based on the drawing input. Further, the selection module 307 filters the map elements, the one or more points of interest, the one or more geographic features, or a combination thereof based on one or more type parameters. In one embodiment, the selection module 307 interacts with the presentation module 209 to display the selected map elements. In one scenario, the selection module 307 may enable drawing strokes along the map, and may set the sample rate to be high (e.g., every 4 pixels). In one example embodiment, the selection module 307 may implement predefined color, a pattern, opacity, stroke width, or a combination thereof to support selection of a BID. The selection module 307 may implement one or more parameters, for example:
query_radius: radius (in meters) of the selection of all BIDs within radius will be selected.
POI_category: category for the selection (optional).

In another scenario, while drawing the stroke, each point draw get its latitude (lat) and longitude (lon)

BIDS = queryPoint(lat,lon, query_radius);
If (selection is enabled) {
categories = categoriesInBIDs(BIDS);
for each element e in categories
if (e.category == POI_category)
select(e.BID)
} else // selection not enabled
For all b in BIDS:
select(e.BID).

The control logic 301 and the annotation module 309 may generate one or more annotations of the one the one or more map elements that are selected. As noted previously, the annotations are persistent, collaborative, or a combination thereof. Further, the annotation module 309 facilitates collaboration on the map with other users of UE 101 through communication module 207.

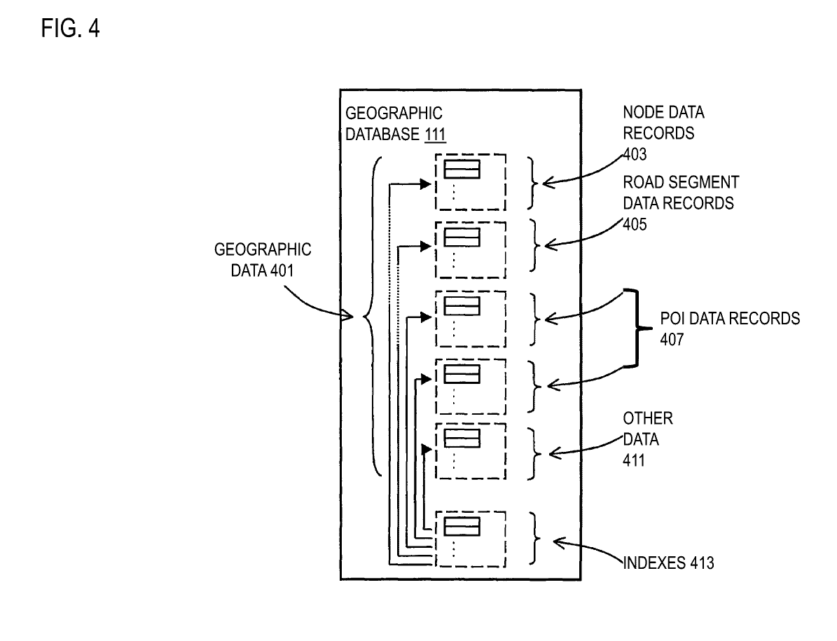

FIG. 4 is a diagram of geographic database 111 of system 100, according to exemplary embodiments. In the exemplary embodiments, POIs and map generated POIs data can be stored, associated with, and/or linked to the geographic database 111 or data thereof. In one embodiment, the geographic or map database 111 includes geographic data 401 used for (or configured to be compiled to be used for) mapping and/or navigation-related services, such as for personalized route determination, according to exemplary embodiments. For example, the geographic database 111 includes node data records 403, road segment or link data records 405, POI data records 407, and other data records 411, for example. More, fewer or different data records can be provided. In one embodiment, the other data records 411 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records 405 are links or segments representing roads, streets, or paths, as can be used in the calculated route or recorded route information for determination of one or more personalized routes, according to exemplary embodiments. The node data records 403 are end points corresponding to the respective links or segments of the road segment data records 405. The road link data records 405 and the node data records 403 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 407. The geographic database 111 can also include data about places, such as cities, towns, or other communities, and other geographic features, such as bodies of water, mountain ranges, etc. Such place or feature data can be part of the POI data records 407 or can be associated with POIs or POI data records 407 (such as a data point used for displaying or representing a position of a city). In addition, the geographic database 111 can include data from radio advertisements associated with the POI data records 407. By way of example, a street is determined from the user interaction with the UE 101 and the content information associated with UE 101, according to the various embodiments described herein.

The geographic database 111 can be maintained by the content provider in association with the services platform 113 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., UEs 101) to provided navigation-related functions. For example, the geographic database 111 can be used with the end user device 101 to provide an end user with navigation features. In such a case, the geographic database 111 can be downloaded or stored on the end user device UE 101, such as in applications 103, or the end user device UE 101 can access the geographic database 111 through a wireless or wired connection (such as via a server and/or the communication network 107), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions such as guidance and map display, for example, and for determination of one or more personalized routes or route segments based on one or more calculated and recorded routes, according to exemplary embodiments.

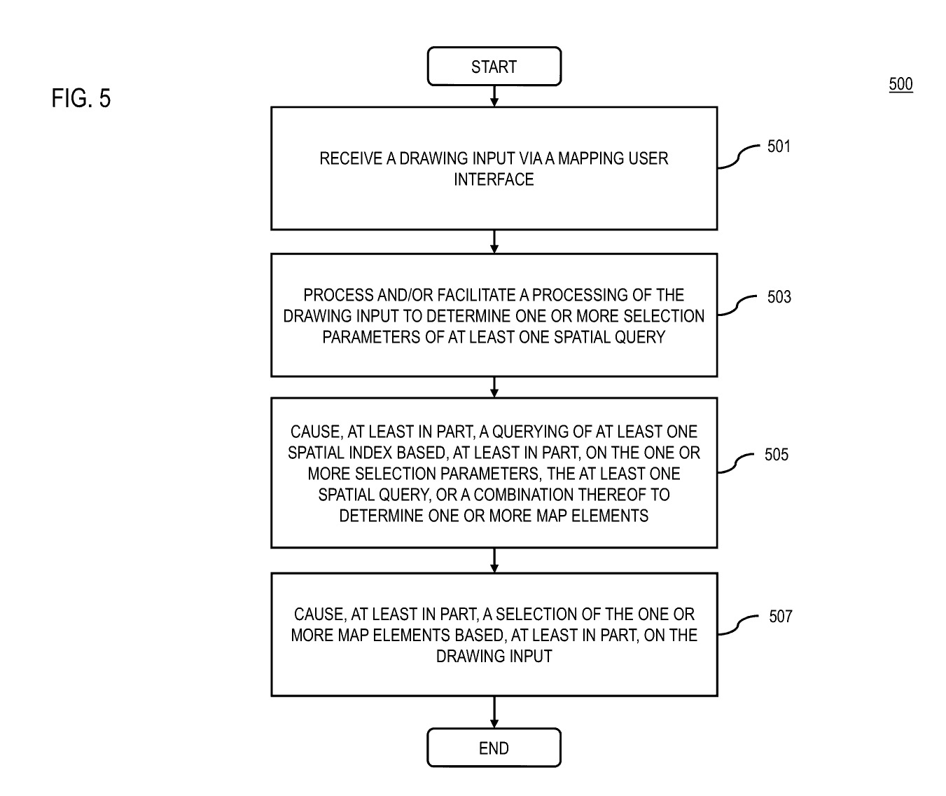

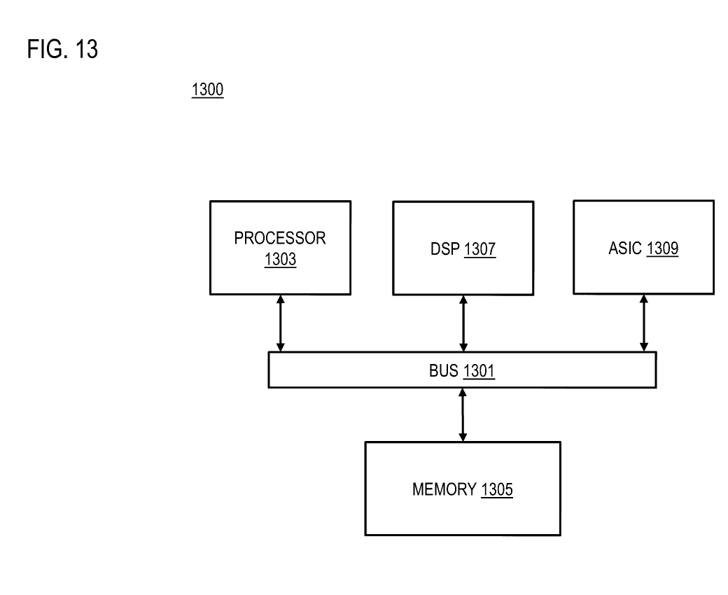

FIG. 5 is a flowchart of a process for selecting map elements for receiving drawing inputs on a mapping user interface, according to one embodiment. In one embodiment, the interaction platform 109 performs processes 500 and is implemented in, for instance, a chip set including a processor and a memory as shown in FIG. 13.

In step 501, the interaction platform 109 receives a drawing input via a mapping user interface. As noted previously, the drawing input may be a line, a polygon, a polyline, or any other arbitrary shape drawn by the user on the mapping user interface of UE 101. For example, the user may select a building by drawing a polygon around it.

Per step 503, the interaction platform 109 processes the drawing input to determine one or more selection parameters of at least one spatial query. As noted previously, the selection parameters may include input geographic coordinates.

In step 505, the spatial index 119 is queried by the interaction platform 109 based on the one or more selection parameters, the at least one spatial query, or a combination thereof, to determine one or more map elements. As noted previously, the spatial index 119 indexes one or more footprints of one or more geographic features. For example, the geographic features include, at least in part, one or more buildings, one or more map geographic areas, one or more streets, one or more waterways, one or more paths, or a combination thereof.

In step 507, the interaction platform 109 causes, at least in part, a selection of the one or more map elements based, at least in part, on the drawing input. In one embodiment, the selected map elements may be highlighted on the map. For example, the highlighted map elements may be displayed in different colors or a pattern. Therefore, the interaction platform 109 enables a user to select map elements based on drawing inputs.

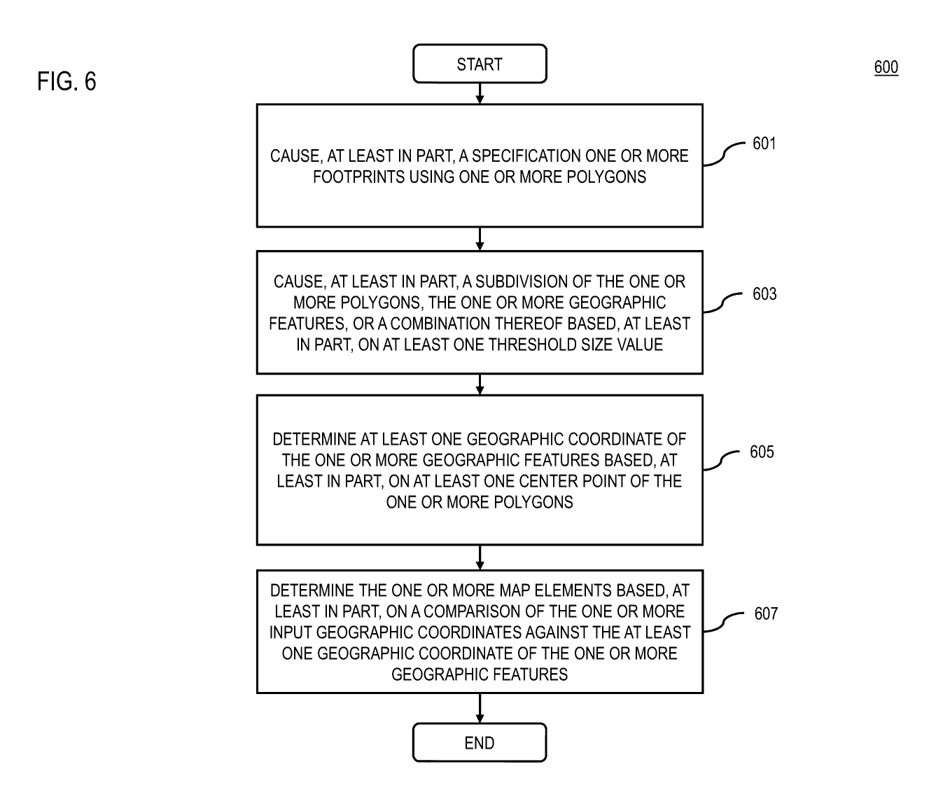

FIG. 6 is a flowchart of a process for determining one or more map elements from one or more input geographic coordinates of one or more footprints, according to one embodiment. In one embodiment, the interaction platform 109 performs processes 600 and is implemented in, for instance, a chip set including a processor and a memory as shown in FIG. 13.

In step 601, the interaction platform 109 causes, at least in part, a specification of one or more footprints using one or more polygons. For example, the footprints may relate to geographic features having large areas or size such as a streets, parks, waterways, etc. Therefore, selecting map elements inside these geographic features may require their subdivision into smaller polygons.

Per step 603, the interaction platform 109 causes, at least in part, a subdivision of the one or more polygons, the one or more geographic features, or a combination thereof based, at least in part, on at least one threshold size value. By way of example, a geographic feature such a street may be broken down into street map element by intersection points; or a large area such as a park may be subdivided into small sections for selecting map elements in their interior portions.

In step 605, the interaction platform 109 determines at least one geographic coordinate of the one or more geographic features based, at least in part, on at least one center point of the one or more polygons. In one embodiment, the geographic coordinate of the geographic features are inserted in the spatial index 119.

Per step 607, the interaction platform 109 determines the one or more map elements based, at least in part, on a comparison of the one or more input geographic coordinates against the geographic coordinate of the geographic features. By way of example, the input geographic coordinates may relate to the coordinates of points on the drawing input provided by the user (e.g., points on a polyline drawn over a street shown on the map). Further, the spatial index 119 includes associated of the geographical coordinates with the BIDs. Therefore, the comparison of the input geographic coordinates with the geographical coordinates in the spatial index 119 may facilitate selection of the map elements. In an exemplary scenario, drawing a polygon around a building on the map may enable the user to select and/or display information related to the building.

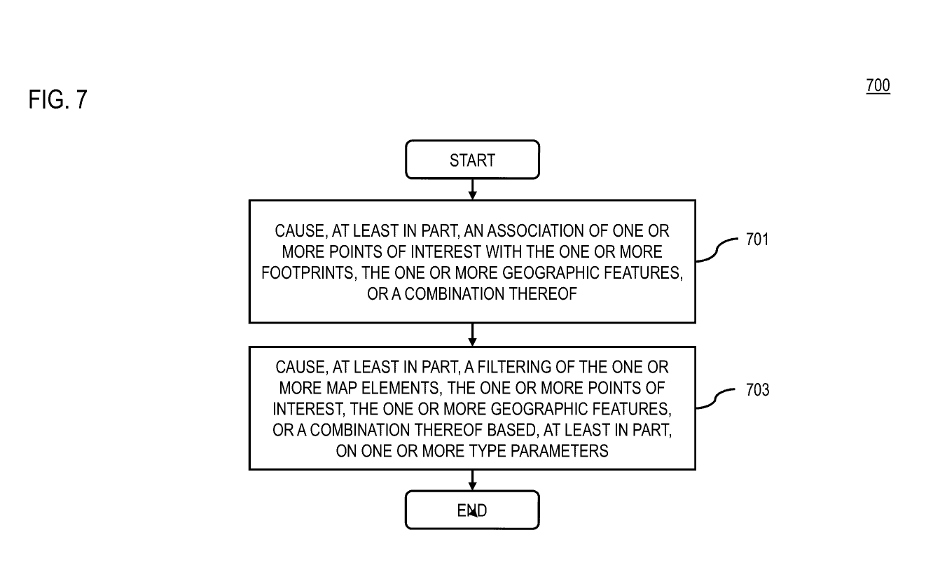

FIG. 7 is a flowchart of a process for causing association of one more points of interests with one more footprints, according to one embodiment. In one embodiment, the interaction platform 109 performs processes 700 and is implemented in, for instance, a chip set including a processor and a memory as shown in FIG. 13.

In step 701, the interaction platform 109 causes, at least in part, an association of one or more points of interest (POI) with the one or more footprints, the one or more geographic features, or a combination thereof. In one embodiment, the POI information may be determined by the interaction platform 109 from the geographic database 117, spatial index 119, or a combination thereof. As noted previously, the POIs may be associated with unique identifier (e.g., BID) of geographic features. In one embodiment, the type parameter (e.g., a restaurant, a coffee shop, etc.) related to the POI may also be associated with the footprints of the geographic features.

The interaction platform 109, per step 703, causes, at least in part, a filtering of the one or more map elements, the one or more points of interest, the one or more geographic features, or a combination thereof based, at least in part, on one or more type parameters. By way of example, the user can draw a polyline over street intersection on the map, which may result in selection of all building near the polyline (e.g., within 10 meters on both sides of the line). Subsequently, the user may be provided an option to select a type parameter for a POI, and accordingly the POIs meeting the type parameters may be selected. In one embodiment, the type parameter may be determined from a user profile or context, for example the time of day, day of week, user age, gender etc.

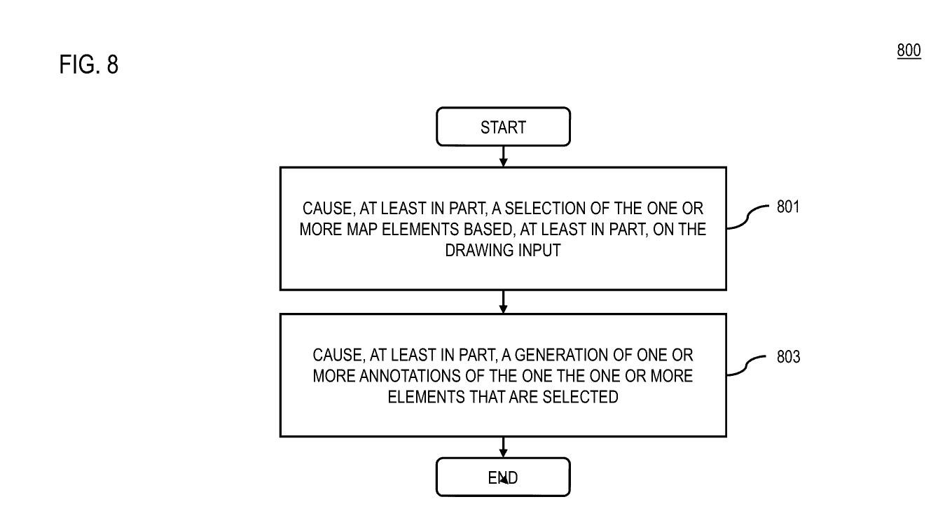

FIG. 8 is a flowchart of a process for generating annotations of the map elements, according to one embodiment. In one embodiment, the interaction platform 109 performs processes 800 and is implemented in, for instance, a chip set including a processor and a memory as shown in FIG. 13.

In step 801, the interaction platform 109 causes, at least in part, a selection of the one or more map elements based, at least in part, on a drawing input. As noted previously, the drawing input may be received from the user on a mapping user interface of UE 101. In one scenario, drawing input enables finer control over selection, for example, drawing on a map allows finer control by restricting selection and filtering only the areas a user is interested in. The users may draw on a map to quickly generate a map of their interest while keeping input simple and output meaningful.

Per step 803, the interaction platform 109 causes, at least in part, a generation of one or more annotations of the one or more map elements that are selected. In one embodiment, the one or more annotations are persistent, collaborative, or a combination thereof. Further, the annotations can be shared with other users or UE 101 communication module 207 of the interaction platform 109. Therefore, the users can interact more effectively and naturally with a map. Further, the interaction platform 109 provides a means for real-time collaborative mapping and way finding. Also, efficient mechanism for performing search and planning on digital maps is provided.

FIG. 9 is an exemplary portion of a map 900 illustrating additional points in polygons, according to one embodiment. As noted previously, the interaction platform 109 causes a subdivision of polygons based on the threshold size value. As shown, the polygon 901 is subdivided into smaller polygons so that they can be selected by drawing inputs from the user.

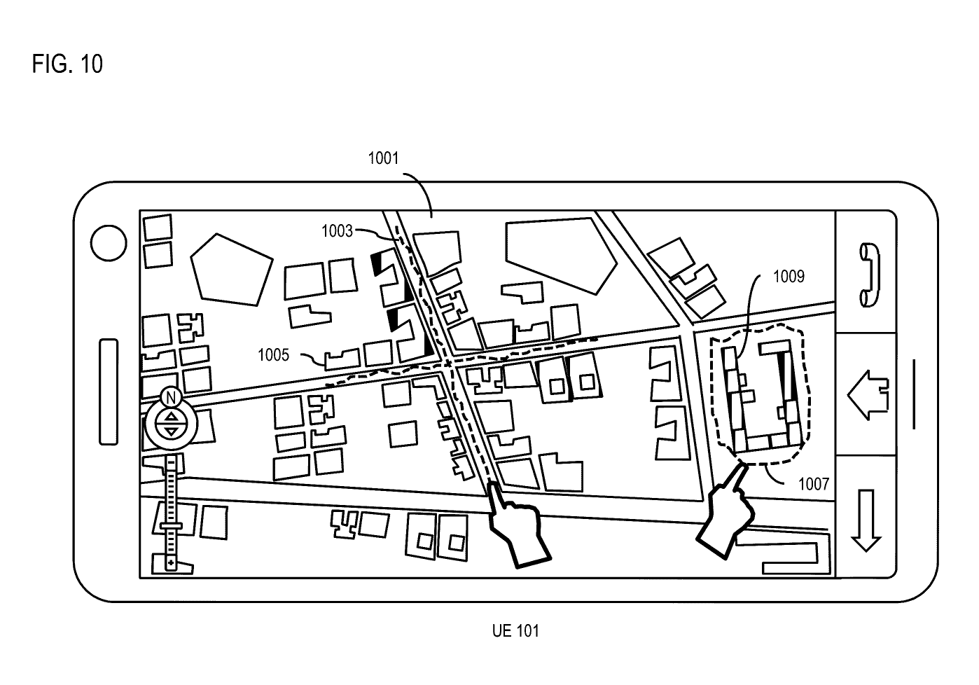

FIG. 10 is a diagram of a user interface 1001 utilized in the processes of FIGS. 5-8, according to one embodiment. As shown in figure, polylines 1003 may be drawn on the mapping user interface 1001 of UE 101 to select one or more map elements 1005. As noted previously, the map elements 1005 may be selected based on predefined threshold distance from the polylines 1003. For example, map elements within 10 meters on either side of the polylines 1003 may be selected. In one embodiment, the user can specify the threshold distance for selection of the map elements. Similarly, as shown, the user can draw a polygon 1007 to select map elements 1009 within the polygon 1007.

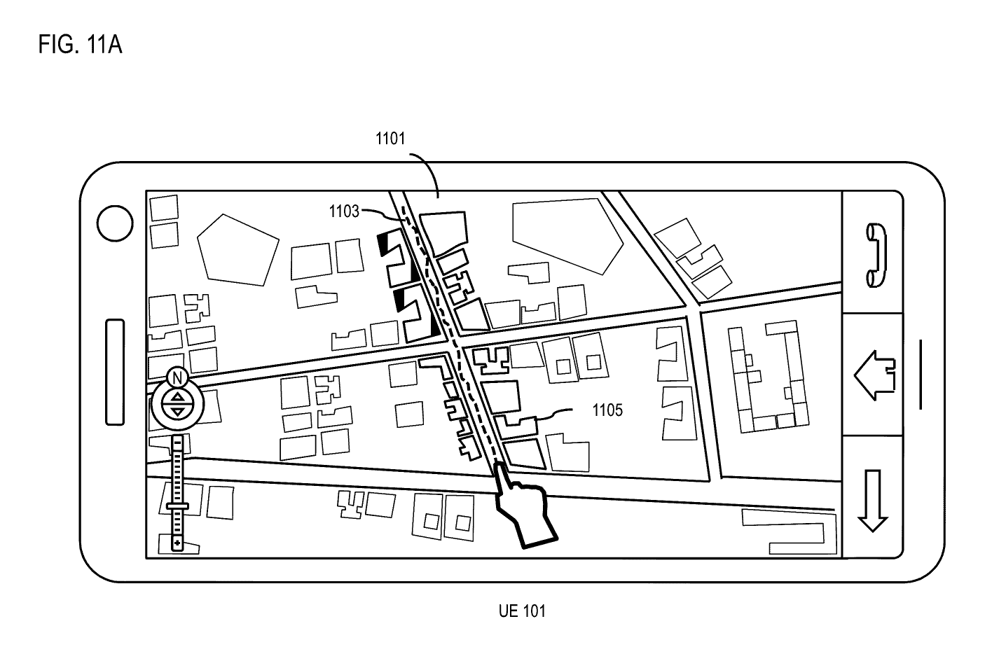

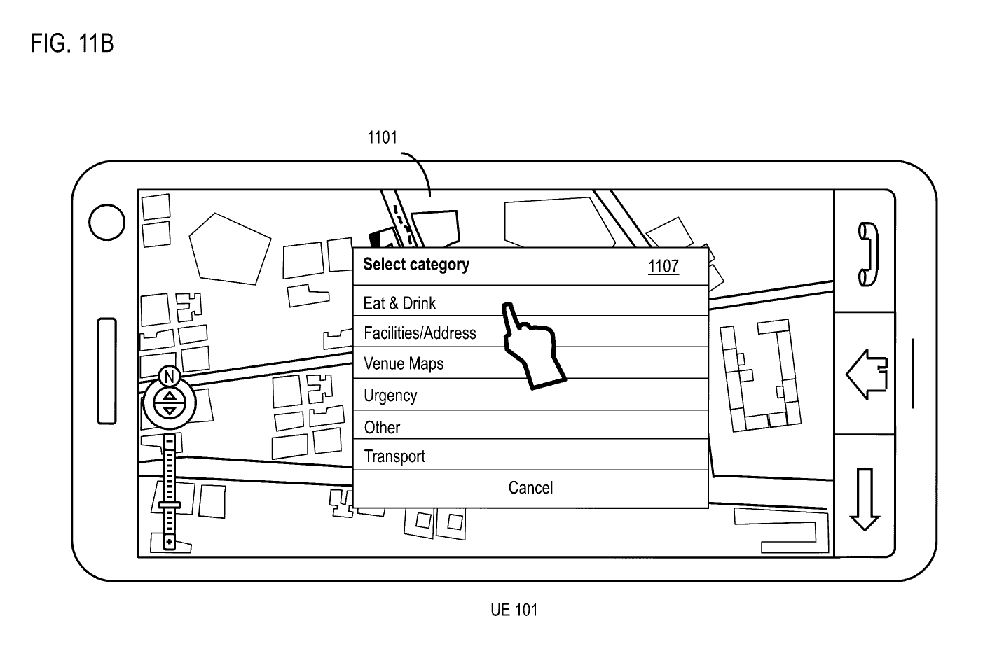

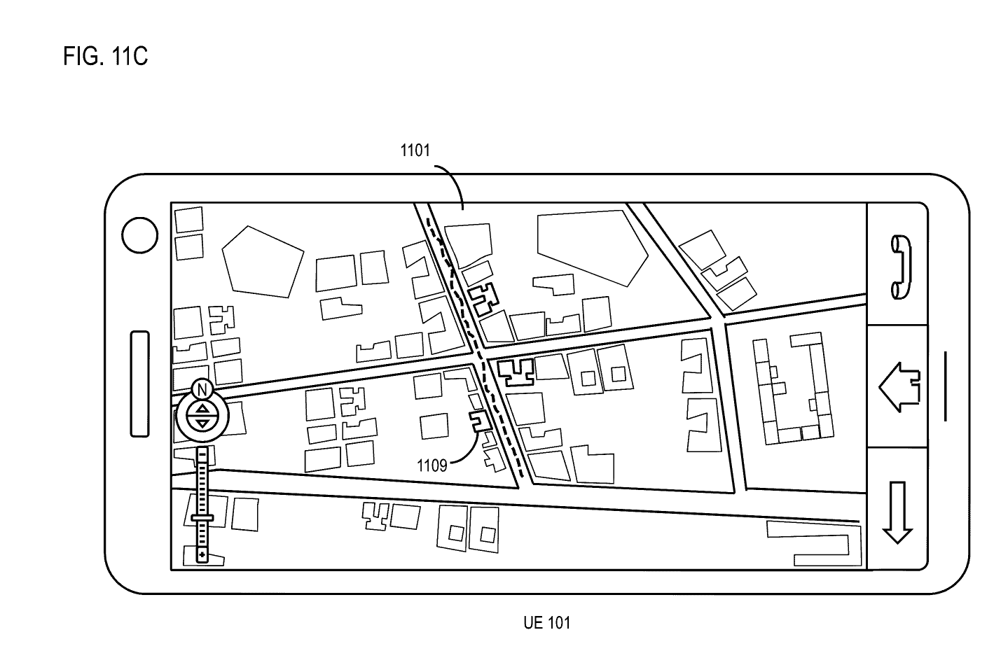

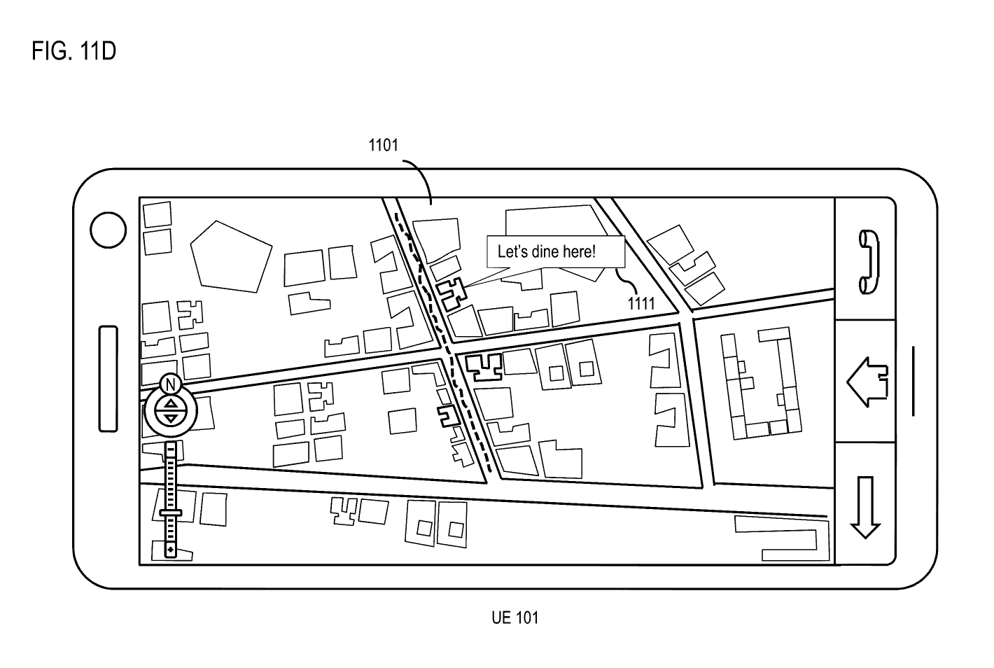

FIGS. 11A-11D are diagrams of a user interface 1101 utilized in the processes of FIGS. 5-8, according to one embodiment. As shown in FIG. 11A, a user draws a line 1103 on the user interface 1101. Subsequently, the interaction platform 109 selects map elements 1105 along the line 1103. As noted previously, the map elements 1105 may be selected based on a predefined threshold distance from the line 1103, or the distance may be specified by the user.

Further, the user may apply filters on the selected map elements 1105. FIG. 11B illustrates a user interface element 1107 (e.g., a pop-up selection display) from where the user can select a type parameter or a category for selecting the map elements. By way of example, the user may select “Eat & Drink” category from the user interface element 1107. Subsequently, the map elements 1105 may be filtered to select only the filtered map elements 1109 (e.g., restaurants, coffee shops, diner etc.), as shown in FIG. 11C.

Moreover, as shown in FIG. 11D, the user can provided annotation 1111 on a selected map element. In one embodiment, the annotation 1111 can be shared in real-time with collaborators.

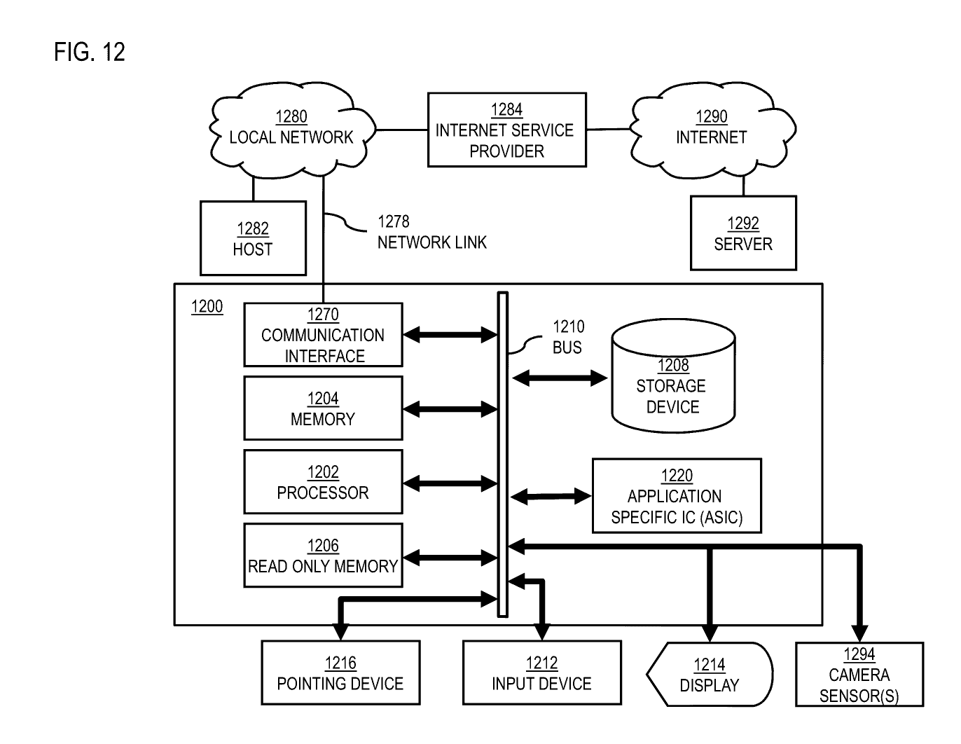

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to process one or more user interactions and/or drawing inputs with the mapping user interface to a cause selection of one or more map elements, as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of processing one or more user interactions and/or drawing inputs with the mapping user interface to a cause selection of one or more map elements.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to processing one or more user interactions and/or drawing inputs with the mapping user interface to a cause selection of one or more map elements. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1200 also includes a memory 1204 coupled to bus 1210. The memory 1204, such as a random access memory (RAM) or any other dynamic storage device, stores information including processor instructions for processing one or more user interactions and/or drawing inputs with the mapping user interface to a cause selection of one or more map elements. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for processing one or more user interactions and/or drawing inputs with the mapping user interface to a cause selection of one or more map elements, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214, and one or more camera sensors 1294 for capturing, recording and causing to store one or more still and/or moving images (e.g., videos, movies, etc.) which also may comprise audio recordings. In some embodiments, for example, in embodiments in which the computer system 1200 performs all functions automatically without human input, one or more of external input device 1212, display device 1214 and pointing device 1216 may be omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 107 for processing one or more user interactions and/or drawing inputs with the mapping user interface to a cause selection of one or more map elements, on the UE 101.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set or chip 1300 upon which an embodiment of the invention may be implemented. Chip set 1300 is programmed to process one or more user interactions and/or drawing inputs with the mapping user interface to a cause selection of one or more map elements, as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of processing one or more user interactions and/or drawing inputs with the mapping user interface to a cause selection of one or more map elements.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to process one or more user interactions and/or drawing inputs with the mapping user interface to a cause selection of one or more map elements. The memory 1305 also stores the data associated with or generated by the execution of the inventive steps.

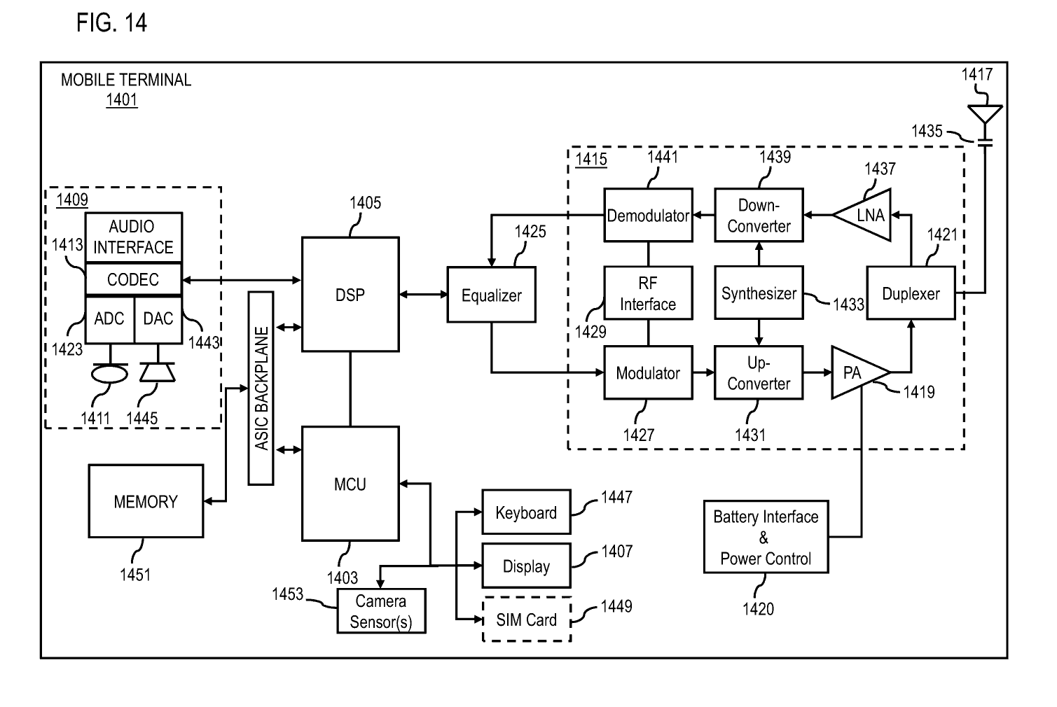

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of processing one or more user interactions and/or drawing inputs with the mapping user interface to a cause selection of one or more map elements. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of processing one or more user interactions and/or drawing inputs with the mapping user interface to a cause selection of one or more map elements. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to process one or more user interactions and/or drawing inputs with the mapping user interface to a cause selection of one or more map elements. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

Further, one or more camera sensors 1453 may be incorporated onto the mobile station 1401 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a drawing input via a mapping user interface;
processing and/or facilitating a processing of the drawing input to determine one or more selection parameters of at least one spatial query;
causing, at least in part, a querying of at least one spatial index based, at least in part, on the one or more selection parameters, the at least one spatial query, or a combination thereof to determine one or more map elements, wherein the at least one spatial index indexes one or more footprints of one or more geographic features; and
causing, at least in part, a selection of the one or more map elements based, at least in part, on the drawing input.

2. A method of claim 1, wherein the one or more geographic features include, at least in part, one or more buildings, one or more map geographic areas, one or more streets, one or more waterways, one or more paths, or a combination thereof.

3. A method of claim 1, further comprising:
causing, at least in part, a specification one or more footprints using one or more polygons.

4. A method of claim 3, further comprising:
causing, at least in part, a subdivision of the one or more polygons, the one or more geographic features, or a combination thereof based, at least in part, on at least one threshold size value.

5. A method of claim 3, further comprising:
determining at least one geographic coordinate of the one or more geographic features based, at least in part, on at least one center point of the one or more polygons,
wherein the at least one spatial index further includes, at least in part, the at least one geographic coordinate.

6. A method of claim 5, wherein the one or more selection parameters include, at least in part, one or more input geographic coordinates, the method further comprising:
determining the one or more map elements based, at least in part, on a comparison of the one or more input geographic coordinates against the at least one geographic coordinate of the one or more geographic features.

7. A method of claim 1, further comprising:
causing, at least in part, an association of one or more points of interest with the one or more footprints, the one or more geographic features, or a combination thereof,
wherein the selection of the one or more map elements includes, at least in part, a selection of the one or more points of interest.

8. A method of claim 7, further comprising:
causing, at least in part, a filtering of the one or more map elements, the one or more points of interest, the one or more geographic features, or a combination thereof based, at least in part, on one or more type parameters.

9. A method of claim 1, wherein the at least one spatial index is based, at least in part, one or more tree data structures, and wherein the one or more tree data structures include, at least in part, a k-dimensional tree data structure, a quadtree data structure, an R*-tree data structure, a R-tree data structure, or a combination thereof.

10. A method of claim 1, further comprising:
causing, at least in part, a generation of one or more annotations of the one or more map elements that are selected,
wherein the one or more annotations are persistent, collaborative, or a combination thereof.

11. An apparatus comprising:
at least one processor; and
at least one memory including computer program code for one or more programs,
the at least one memory and the computer program code configured to, with the at least one processor, cause the apparatus to perform at least the following;
receive a drawing input via a mapping user interface;
process and/or facilitate a processing of the drawing input to determine one or more selection parameters of at least one spatial query;
cause, at least in part, a querying of at least one spatial index based, at least in part, on the one or more selection parameters, the at least one spatial query, or a combination thereof to determine one or more map elements, wherein the at least one spatial index indexes one or more footprints of one or more geographic features; and
cause, at least in part, a selection of the one or more map elements based, at least in part, on the drawing input.

12. An apparatus of claim 11, wherein the one or more geographic features include, at least in part, one or more buildings, one or more map geographic areas, one or more streets, one or more waterways, one or more paths, or a combination thereof.

13. An apparatus of claim 11, wherein the apparatus is further caused to:
cause, at least in part, a specification one or more footprints using one or more polygons.

14. An apparatus of claim 13, wherein the apparatus is further caused to:
cause, at least in part, a subdivision of the one or more polygons, the one or more geographic features, or a combination thereof based, at least in part, on at least one threshold size value.

15. An apparatus of claim 13, wherein the apparatus is further caused to:
determine at least one geographic coordinate of the one or more geographic features based, at least in part, on at least one center point of the one or more polygons,
wherein the at least one spatial index further includes, at least in part, the at least one geographic coordinate.

16. An apparatus of claim 15, wherein the one or more selection parameters include, at least in part, one or more input geographic coordinates, and wherein the apparatus is further caused to:
determine the one or more map elements based, at least in part, on a comparison of the one or more input geographic coordinates against the at least one geographic coordinate of the one or more geographic features.

17. An apparatus of claim 11, wherein the apparatus is further caused to:
cause, at least in part, an association of one or more points of interest with the one or more footprints, the one or more geographic features, or a combination thereof,
wherein the selection of the one or more map elements includes, at least in part, a selection of the one or more points of interest.

18. A computer-readable storage medium carrying one or more sequences of one or more instructions which, when executed by one or more processors, cause an apparatus to perform:
receiving a drawing input via a mapping user interface;
processing and/or facilitating a processing of the drawing input to determine one or more selection parameters of at least one spatial query;
causing, at least in part, a querying of at least one spatial index based, at least in part, on the one or more selection parameters, the at least one spatial query, or a combination thereof to determine one or more map elements, wherein the at least one spatial index indexes one or more footprints of one or more geographic features; and
causing, at least in part, a selection of the one or more map elements based, at least in part, on the drawing input.

19. A method of claim 18, wherein the one or more geographic features include, at least in part, one or more buildings, one or more map geographic areas, one or more streets, one or more waterways, one or more paths, or a combination thereof.

20. A method of claim 18, further comprising:
causing, at least in part, a specification one or more footprints using one or more polygons.

21.-48. (canceled)
